(19) United States
(12) Patent Application Publication
(10) Pub. No.: US 2015/0287078 A1
(43) Pub. Date: Oct. 8, 2015

(54) SYSTEMS AND METHODS OF ENABLING SUCCESSIVE OFFERS FOR THE SALE OF A DIGITAL ASSET OF A DIGITAL SERVICE

(71) Applicant: Electronic Arts, Inc., Redwood City, CA (US)

(72) Inventor: John Kolen, Niceville, FL (US)

(73) Assignee: ELECTRONIC ARTS, INC., Redwood City, CA (US)

(21) Appl. No.: 14/245,965

(22) Filed: Apr. 4, 2014

(51) Int. Cl. G06Q 30/02

(52) U.S. Cl. CPC G06Q 30/0254

(57) ABSTRACT

A system comprises a communications engine configured to receive context information of a user of a digital service, the context information identifying a possible interest of the user in a digital asset of the digital service; a rules engine configured to obtain offer rules associated with the context information; an economic data engine configured to obtain economic data associated with the offer rules; and an offer engine configured to first determine based on the offer rules whether to present a first offer for the digital asset; if the offer engine determines to present the first offer, generate the first offer for the digital asset; if the first offer is refused, second determine based on the offer rules whether to present a successive offer for the digital asset; and if the offer engine determines to present the successive offer, generate the successive offer based on the economic data, the successive offer being designed to be more attractive to the user than the first offer.

### BACKGROUND

1. Technical Field

Embodiments of the present invention relate generally to digital assets. More particularly, embodiments of the invention relate to systems and methods of enabling successive offers for the sale of a digital asset of a digital service to improve conversion rates and enhance profitability.

2. Description of Related Art

Digital services, e.g., mobile device applications, video games, digital portals, etc. often generate revenue by selling digital assets to users, e.g., application users, game players, movie viewers, etc. Digital assets may include software applications, video games, virtual items in video games, video game credits, digital content, etc. For example, in a video game embodiment, a game player negotiates a game avatar through a series of challenges, struggling to ensure that the game avatar has enough virtual energy, virtual health, virtual currency, virtual items and/or other digital assets to survive and/or advance in the game. To protect and/or advance the game avatar, the game player is motivated to obtain digital assets. The game environment may include virtual stores to allow the game player to buy these digital assets. The game player directs the game avatar into a virtual store to browse the digital assets for sale, and if the digital service provider is lucky the game player purchases one or more digital assets. A failed conversion of a digital asset of interest to a user means lost profit opportunity for the digital service provider.

Typically, the cost of a digital asset in a digital service is based on economic factors, e.g., desired profitability, prices for equivalent products, etc. For example, the cost of a digital asset in a video game environment is often based on the efforts of the video game provider to maintain a healthy balance of real currency (real dollars), virtual currency (in game currency often purchased using real dollars), and grind currency (currency generated based on game player efforts and/or accomplishments). The video game provider attempts to balance the three types of currency to tune the virtual economy for maximum profit.

Systems and methods are needed to assist digital service providers to improve conversion rates and enhance profitability.

### SUMMARY

In some embodiments, a system comprises a communications engine configured to receive context information of a user of a digital service, the context information identifying a possible interest of the user in a digital asset of the digital service; a rules engine configured to obtain offer rules associated with the context information; an economic data engine configured to obtain economic data associated with the offer rules; and an offer engine configured to first determine based on the offer rules whether to present a first offer for the digital asset; if the offer engine determines to present the first offer, generate the first offer for the digital asset; if the first offer is refused, second determine based on the offer rules whether to present a successive offer for the digital asset; and if the offer engine determines to present the successive offer, generate the successive offer based on the economic data, the successive offer being designed to be more attractive to the user than the first offer.

The digital service may include a video game, digital content delivery, and/or software application management. The economic data may include pricing information set by a digital service provider, individual user behavior information of the user, and/or behavior information of a user group to which the user belongs or is associated. The system may further comprise an offer exchange server that sends the first offer to the user, and/or an offer exchange server that sends the first offer to a user agent. The first offer and the successive offer may comprise different payment types or combinations of payment types.

In some embodiments, a method comprises receiving context information of a user of a digital service, the context information identifying a possible interest of the user in a digital asset of the digital service; obtaining offer rules associated with the context information; obtaining economic data associated with the offer rules; first determining based on the offer rules whether to present a first offer for the digital asset; if a first determination is made to present the first offer, generating the first offer for the digital asset; if the first offer is refused, second determining based on the offer rules whether to present a successive offer for the digital asset; and if a second determination is made to present the successive offer, generating the successive offer based on the economic data, the successive offer being designed to be more attractive to the user than the first offer.

The digital service may include a video game, digital content delivery, and/or software application management. The economic data may include pricing information set by a digital service provider, individual user behavior information of the user, and/or behavior information of a user group to which the user belongs or is associated. The method may further comprise sending the first offer to the user, and/or sending the first offer to a user agent. The first offer and the successive offer may comprise different payment types or combinations of payment types.

In some embodiment, a computer readable medium comprises instructions, the instructions being executable by a processor to perform a method, the method comprising receiving context information of a user of a digital service, the context information identifying a possible interest of the user in a digital asset of the digital service; obtaining offer rules associated with the context information; obtaining economic data associated with the offer rules; first determining based on the offer rules whether to present a first offer for the digital asset; if a first determination is made to present the first offer, generating the first offer for the digital asset; if the first offer is refused, second determining based on the offer rules whether to present a successive offer for the digital asset; and if a second determination is made to present the successive offer, generating the successive offer based on the economic data, the successive offer being designed to be more attractive to the user than the first offer.

### BRIEF DESCRIPTION OF THE DRAWINGS

FIG. 1 is a block diagram of a network system configured to enable successive offers for the sale of a digital asset of a digital service, in accordance with some embodiments of the invention.

FIG. 2 is a block diagram of a digital service system, in accordance with some embodiments of the invention.

FIG. 3 is a block diagram of a user system, in accordance with some embodiments of the invention.

FIG. 4 is a block diagram of an offer server system, in accordance with some embodiments of the invention.

FIG. 5 is a flow diagram of a user interface, in accordance with some embodiments of the invention.

FIG. 6 is a block diagram of a data store, in accordance with some embodiments of the invention.

FIG. 7A is a block diagram of individual user data, in accordance with some embodiments of the invention.

FIG. 7B is a block diagram of user group data, in accordance with some embodiments of the invention.

FIG. 7C is a block diagram of other economic factors, in accordance with some embodiments of the present invention.

FIG. 8 is a block diagram of a user agent, in accordance with some embodiments of the invention.

FIGS. 9A and 9B are a flowchart of a method of enabling successive offers for the sale of a digital asset of a digital service, in accordance with some embodiments of the invention.

FIG. 10 is a block diagram of an exemplary digital device.

### DETAILED DESCRIPTION OF EMBODIMENTS

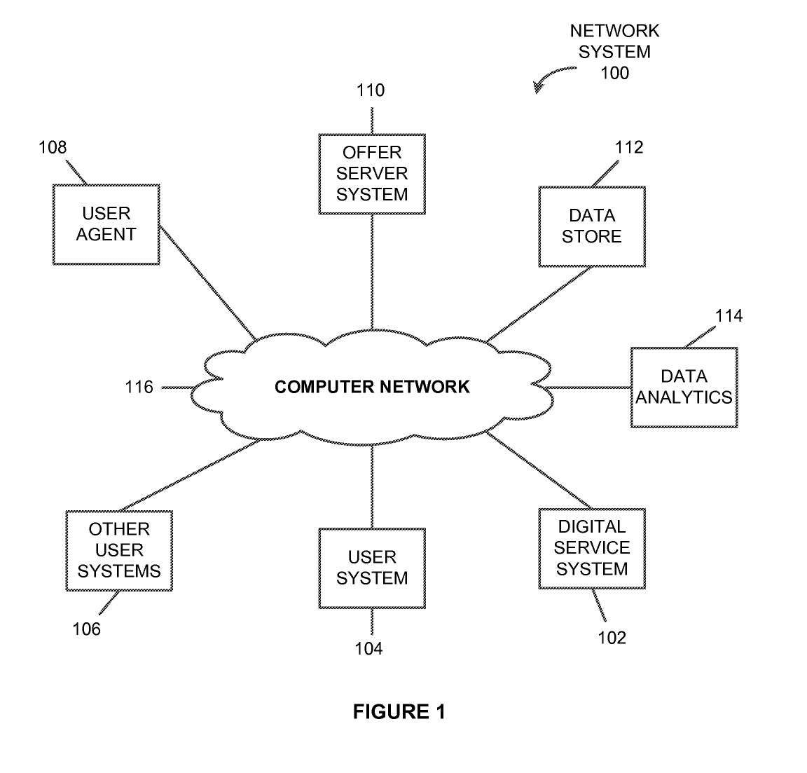

FIG. 1 is a block diagram of a network system 100 configured to enable successive offers for the sale of a digital asset of a digital service to a potentially interested user, in accordance with some embodiments of the invention. Network system 100 includes a digital service system 102 (e.g., video server, game server, application server), a user system 104, other user systems 106, a user agent 108, an offer server system 110, a data store 112, and data analytics 114, each coupled to a computer network 116.

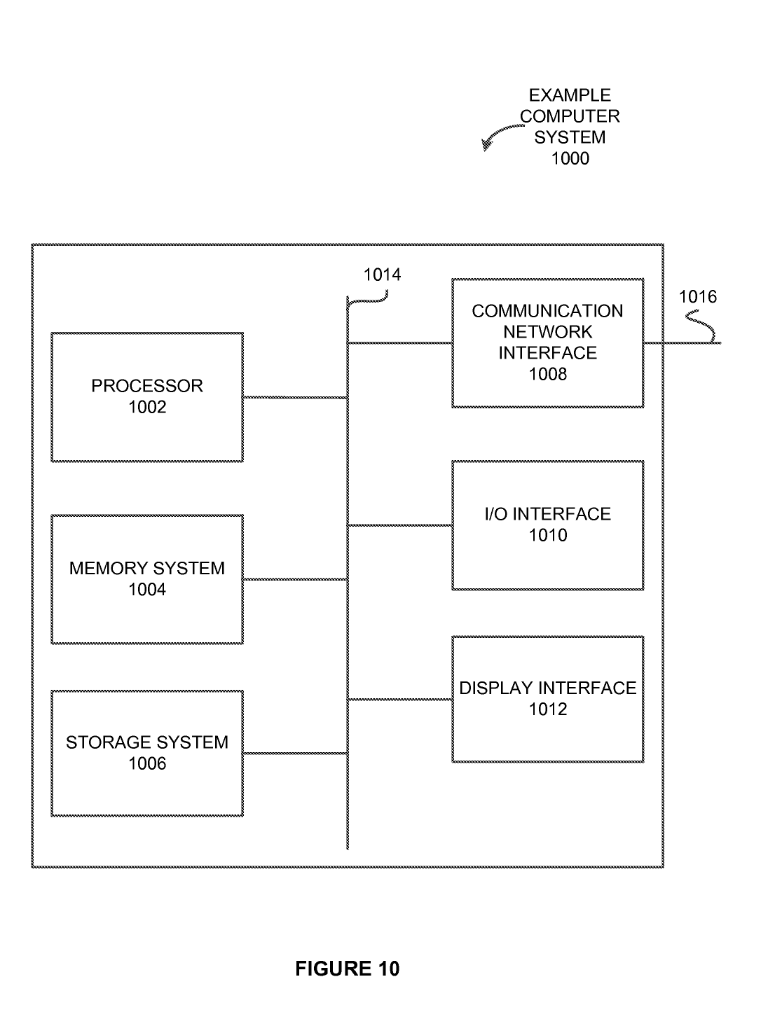

The digital service system 102 includes one or more computer systems configured to provide a digital service to users. An example computer system is shown in FIG. 10. Example digital services include digital content delivery services, application delivery services, video game delivery services, application processing services, video game processing services, etc. The digital service system 102 offers digital assets for sale to the users. Examples of digital assets may include a video, music, an application, a video game, virtual items in a video game (e.g., energy, health, weapons, lives, currency), features in an application, etc. A user may be interested and willing to purchase a digital asset from the digital service system 102.

To support conversion rates and enhance profitability, the digital service system 102 may be configured to enable successive offers for the sale of a digital asset to a potentially interested user. A potentially interested user is a user of the digital service system 102 who is known or suspected to have interest in a digital asset but who may or may not be willing to purchase the digital asset at the given price. A successive offer is an offer subsequent to a previous offer that is generated based on the fact that the potentially interested user has rejected the previous offer. The successive offer is typically more attractive to the user. For example, a first offer may be an offer for a digital asset at a first price. The successive offer may be a second offer for the digital asset at a lower price. Alternatively, the successive offer may be a counteroffer from the user. The plural term “successive offers” refers to a previous offer and the subsequent offer. Successive offers need not be offers that immediately follow one another. There can be intermediate offers, possibly pertaining to other digital assets. A “first offer” need not be an initial offer to a user for the digital asset. Successive offers need not be for the same payment type. That is, a first offer and a successive offer need not both be for real currency. Successive offers can be for different payment types or combinations of payment types. For example, a first offer may be an offer to sell a digital asset for real currency. The second offer may be an offer to sell the digital asset for the user to watch several advertisements or a combination of real currency and advertisements.

In some digital content delivery embodiments, the digital service system 102 offers digital content, e.g., movies or music, to users. A user may navigate to a digital page, e.g., within a mobile phone application, on a set top box, via a computer browser, etc., that offers the digital content for purchase. The digital service system 102 monitors for a trigger that signals a time to report the potentially interested user's context to the offer server system 110 (e.g., a time that identifies a known or suspected interest of the user in the digital content). Upon identifying a trigger, the digital service system 102 informs the offer server system 110 of the user's context. Examples of a user's context may include the user playing a trailer, looking at the price of the digital content, navigating to a particular web page, etc. As will be described below, the offer server system 110 determines whether to generate and present each of one or more offers to the potentially interested user for the sale of the digital content known or suspected of interest to the user based on the context. The digital service system 102 presents the one or more offers to the potentially interested user, and informs the offer server system 110 of rejections, acceptances and/or counteroffers. The digital service system 102 fulfills an accepted offer, e.g., by effecting the transaction and providing the digital content to the purchasing user. It will be appreciated that other components in the network 100 can effect the transaction or parts of the transaction instead of the digital service system 102. It will be appreciated that the digital service system 102, the offer server system 110, or other components in the network system 100 may determine whether the context identifies an interest or suspected interest of the user in the digital content.

In some video game embodiments, the digital service system 102 may provide video game processing for one or more players. For example, one or more players may each negotiate a game avatar through a series of challenges, struggling to ensure that the game avatar has enough virtual energy, virtual health, virtual currency, virtual items and/or other digital assets to survive and/or advance in the game. To protect and/or advance the game avatar, the game player may wish to obtain digital assets. In some embodiments, the game environment may include virtual stores to allow the game player to buy digital assets. The game player directs the game avatar into a virtual store to browse the digital assets for sale. In some video game embodiments, the digital service system 102 monitors for a trigger that signals a time to report the user's context to the offer server system 110 (e.g., a time that identifies a known or suspected interest of the video game player in a digital asset). Example triggers may include a known or suspected need to obtain a digital asset to enable the user to progress to the next level, a known or suspected desire of the user to obtain a digital asset based on the user's behavior (e.g., reviewing the details of a virtual item in a virtual store), another user's procurement of the digital asset (e.g., by a cohort or member of the user's demographic), etc. Upon identifying a trigger, the digital service system 102 informs the offer server system 110 of the context. Examples of a user's context may include the level, the digital asset of likely interest, relevant user behavior, the number of items needed to progress to the next level, and/or the like. As will be described below, the offer server system 110 determines whether to generate and present each of one or more offers to the potentially interested user for the sale of the digital asset known or suspected of interest to the user based on the context. The digital service system 102 presents the one or more offers to the potentially interested user, and informs the offer server system 110 of rejections, acceptances and/or counteroffers. The digital service system 102 fulfills an accepted offer, e.g., by effecting the transaction and providing the digital asset to the purchasing user. It will be appreciated that other components in the network 100 can effect the transaction or parts of the transaction instead of the digital service system 102. It will be appreciated that the digital service system 102, the offer server system 110, or other components in the network system 100 may determine whether the context identifies an interest or suspected interest of the user in the digital asset.

In some application management embodiments, the digital service system 102 may offer a software application, e.g., a new OS, a mobile device app, a computer system application, a video game, etc., to users (e.g., for download, remote execution, etc.). The user may navigate to a digital page, e.g., within a mobile phone application, on a set top box, via a computer browser, etc., that offers the application for purchase. The digital service system 102 monitors for a trigger that signals a time to report the user's context to the offer server system 110 (e.g., a time that identifies a known or suspected interest of the user in the application). Upon identifying a trigger, the digital service system 102 informs the offer server system 110 of the user's context. Examples of a user's context may include the user clicking on an application within an application store, visiting a particular website, etc. As will be described below, the offer server system 110 determines whether to generate and present each of one or more offers to the potentially interested user for the sale of the digital asset known or suspected of interest to the user based on the context. The digital service system 102 presents the one or more offers to the potentially interested user, and informs the offer server system 110 of rejections, acceptances and/or counteroffers. The digital service system 102 fulfills an accepted offer, e.g., by effecting the transaction and providing the digital asset to the purchasing user. It will be appreciated that other components in the network 100 can effect the transaction or parts of the transaction instead of the digital service system 102. It will be appreciated that the digital service system 102, the offer server system 110, or other components in the network system 100 may determine whether the context identifies an interest or suspected interest of the user in the digital asset.

The user system 104 includes a computer system configured to interact with and consume the digital service provided by the digital service system 102. The user system 104 may include a mobile device, a laptop, a desktop, a tablet, a game console, a set top box, a smart television, a smart watch, GoogleGlass®, wearable technology, or any computer system. An example computer system is shown in FIG. 10. The digital service system 102 may monitor the behavior of the user of the user system 104 to gather intelligence on the user's interest in digital assets and consumption choices. The other user systems 106 may be similar to the user system 104. The digital service system 102 may monitor the behavior of the users of the other user systems 106 to gather intelligence on the interests and consumption behavior of various users to gather statistics and behaviors of user groups, e.g., particular demographics.

A user agent 108 includes a computer system that is capable of receiving each offer presented by the offer server system 110, possibly around the same time as the user system 104. The user agent 108 may be configured by the user of the user system 104 to accept, reject and/or counter offers for particular digital assets when the price is within specific parameters, should the user be unable to respond when an offer is presented. An example computer system is shown in FIG. 10.

The offer server system 110 includes one or more computer systems configured to receive context information of a user of the digital service, in accordance with some embodiments of the invention. The offer server system 110 applies offer rules based on the context information received to determine whether to provide a first offer, whether to provide each of one or more successive offers, the price of each offer, and whether and when to walk away.

The offer server system 110 accesses the data store 112 to obtain the rules and economic data relevant to the context. Economic data includes pricing information (possibly set by the digital service provider), current and past individual user behavior information of the potentially interested user, user group behavior information of a group of users to which the potentially interested user is related or belongs, and/or other external factors such as time of day, market conditions, weather, etc.), and/or other information. The offer server system 110 may use the economic data, e.g., the pricing information, individual user behavior information, user group behavior information, external factors, and/or the like to decide whether to present a first offer, whether to present each of one or more successive offers, the price of each offer, and/or the like. In some embodiments, behavior information may include information about counteroffers. The offer server system 110 may evaluate previous counteroffers of an individual user or of a user group to decide whether to provide the first offer and/or each of one or more successive offers and to generate prices. The offer server system 110 may evaluate current counteroffers of the individual user (e.g., a counteroffer just presented in response to a previous offer) to decide whether to provide each of one or more successive offers and to generate the price of each successive offer.

The data store 112 includes a database configured to store the offer rules, economic data and/or other data. Economic data includes pricing information (possibly set by the digital service provider), individual user information, current and past individual user behavior information of the individual users, user group information (possibly including one or more user groups to which the potentially interested user is related or belongs), user group behavior information of each user group, and/or other external factors such as time of day, market conditions, weather, etc.), and/or other information. User information may include user name, contact information, age, gender, race, religion, etc. The individual user behavior information may include digital service usage history, context and offer/rejection/walkaway/conversion history, and/or the like. User group behavior information may include general and statistical information about the context and offer/rejections/walkaway/conversion history for groups of users (e.g., based on demographic information). Examples user groups may include men, women, users within certain age ranges, users who have purchased digital assets in the past, users with game consoles, etc. In some embodiments, pricing information may include the minimum prices a digital service provider may be willing to sell a digital asset, suggested prices that may be used to generate initial and successive prices, profit goals, etc. The pricing information may also include adjustment rules (which may be based on digital service provider preferences) that define how individual user behavior, user group behavior, external factors and/or other criteria affect whether to present an offer and offer pricing, etc.

It will be appreciated that the offer rules may evaluate the behavior corresponding to a single digital service and/or across one or more digital services. For example, individual user behavior of a user of one digital service may suggest the same user's individual user behavior of different data service. Similarly, the individual user behavior of a cohort or person of like demographic may suggest another user's individual user behavior of the same or a different digital service. Similarly, user group behavior may suggest the individual user behavior of the potentially interested user. The offer rules may include a hierarchy of rules, e.g., that weights individual user behavior more heavily (if enough individual user behavior information is available) or user group behavior more heavily (if there is insufficient individual user behavior information).

The data analytics 114 includes one or more computers configured to process individual and/or user group behavior information to determine economic indicators about an individual's or a user group's buying and consumption behavior, which may be used to suggest the behavior in non-digital or other environments. The information may be used to support the decision whether to present offers and the pricing of those offers in non-digital or other digital environments.

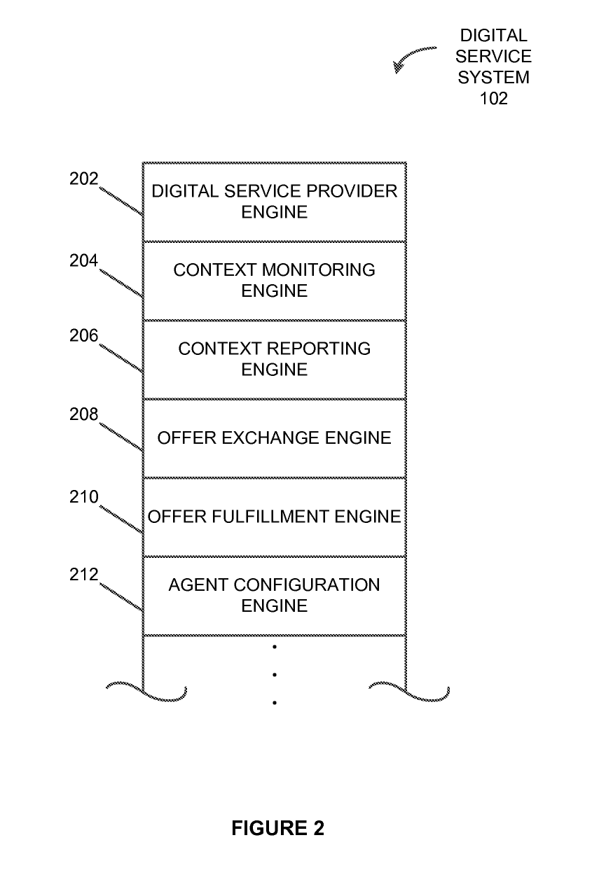

FIG. 2 is a block diagram of a digital service system 102, in accordance with some embodiments of the invention. The digital service system 102 includes a digital service provider engine 202, context monitoring engine 204, context reporting engine 206, offer exchange engine 208, offer fulfillment engine 210 and an agent configuration engine 212.

The digital service provider engine 202 includes hardware, software and/or firmware configured to provide the digital service (e.g., digital content delivery, application management, video game processing, etc.) to the users. In some digital content delivery embodiments, the digital service provider engine 202 may store the digital content and enable download of the digital content upon purchase. In some video game processing embodiments, the digital service provider engine 202 may control the video game process and the provision of digital assets (e.g., virtual items) upon purchase. In some application management embodiments, the digital service provider engine 202 may store the applications and enable download upon purchase. In some application processing embodiments, the digital service provider engine 202 may control access to features upon purchase.

The context monitoring engine 204 includes hardware, software and/or firmware configured to monitor the user behavior and/or state information associated with the digital service for a trigger. A trigger may include the occurrence of one or more specific user actions (e.g., a user navigating into a virtual store, a user clicking on a link to the details of a particular digital asset, etc.), the occurrence of one or more digital service events (e.g., a video game player reaching a particular level, etc.), a trigger score based on a likelihood of a user's interest in a digital asset (e.g., a trigger score based on the likelihood that a user will need an item to pass a video game level, a trigger score based on the amount of time a user spends reviewing a particular movie, a trigger score based on the number of times a user listens to a music clip, etc.), a trigger score based on a likelihood of a user's interest in a digital asset based on past user behaviors (e.g., evaluating current individual user actions of an individual user relative to the previous user actions of the individual user that previously led to a sale or failed sale), a trigger score based on economic indicators (e.g., an increase in the stock market, an increase in a user's spending habits within the game, etc.), and/or a trigger score based on a perceived reduction in user interest in the digital service (e.g., a recognized reduction in a user's game play, the amount of time it has been since the user visited the digital service, etc.), and/or the like.

The context reporting engine 206 includes hardware, software and/or firmware configured to report context information to the offer server system 110 in response to a trigger. The context information reported to the offer server system may include some, the same or more context information than that needed to detect the trigger. In some digital content delivery embodiments, the context information may include user identification information, digital asset identification information, recent user behavior and/or other information. In some video game processing embodiments, the context information may include user identification information, recent user behavior, current level information, current digital assets possessed, immediate risks to the avatar's health or immediate needs to the next achievement, identification of one or more digital assets that will support the user in the game, etc. In some application processing embodiments, the context information may include user identification information, digital asset identification information, recent user behavior information, current applications possessed, etc.

The offer exchange engine 208 includes hardware, software and/or firmware configured to present any offers from the offer server system 110 to the user. The offer exchange engine 208 is also configured to report rejections, acceptances and/or counteroffers to the offer server system 110.

The offer fulfillment engine 210 includes hardware, software and/or firmware configured to fulfill the terms of any accepted offer. In some digital content delivery embodiments, the offer fulfillment engine 210 enables the download of the digital content to the user. In some video game embodiments, the offer fulfillment engine 210 provisions the digital asset for the user. In some application management embodiments, the offer fulfillment engine 210 enables the download of the software application or the provision of application services to the user. In some embodiments, the offer fulfillment engine 210 also effects the payment transaction. In other embodiments, the offer server system 110 effects the payment transaction.

The agent configuration engine 212 includes hardware, software and/or firmware configured to receive configuration information from the user to configure the user agent 108 and the offer server system 110 to present, reject and/or accept offers automatically therebetween. For example, the user through the user device 104 may communicate with the agent configuration engine 212, which in turn sends configuration data to the user agent 108 and to the offer server system 110. Based on the configuration data, when the offer server system 110 decides to present an offer, the offer server system 110 may send the offer to both the user system 104 and to the user agent 108. Based on parameters provided by the user, the user agent 108 may automatically reject, accept and/or counter an offer, as the user's proxy.

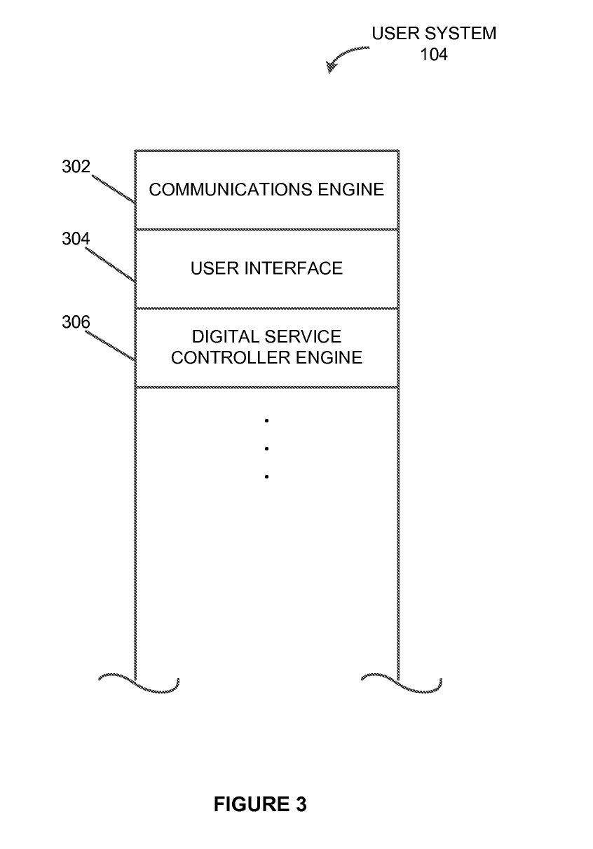

FIG. 3 is a block diagram of the user system 104, in accordance with some embodiments of the invention. The user system 104 includes a communications engine 302, a user interface 304 and a digital service controller engine 306. The communications engine 302 includes hardware, software and/or firmware configured to enable network communications, e.g., over wire or wireless channels. The user interface 304 includes hardware, software and/or firmware configured to enable a user to interact with the user system 104 and enjoy the digital assets of the digital service (e.g., watch the video, execute or use the application, play the video game, etc.). In some embodiments, the user interface 304 includes a keyboard, mouse, display screen, motion detector, camera, touch screen, and/or other sensor. The digital service controller engine 306 includes hardware, software and/or firmware configured to enable communication with the digital service provider system 202 of the digital service system 102. Using the digital service controller engine 306, the user of the user device 104 can control and enjoy the digital service, respond to offers and/or invitations for counter offers, etc. In some embodiments, the other user systems 106 are similar to the user system 104.

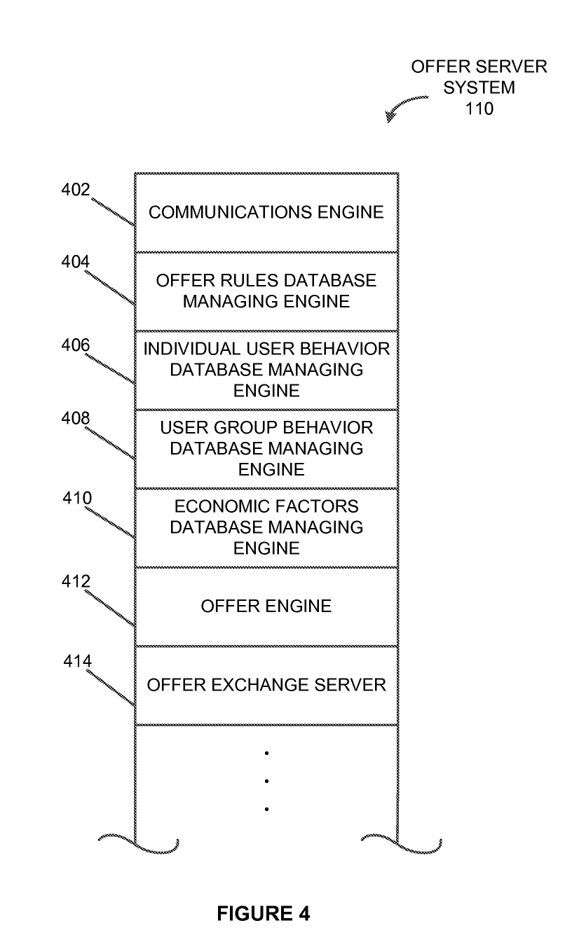

FIG. 4 is a block diagram of the offer server system 110, in accordance with some embodiments of the invention. The offer server system 110 includes a communications engine 402, an offer rules database managing engine 404, an individual user behavior database managing engine 406, a user group behavior database managing engine 408, an economic factors database managing engine 410, an offer engine 412, and an offer exchange server 414.

The communications engine 402 includes hardware, software and/or firmware configured to receive the context information, responses to offers, counteroffers, and other information from the digital service system 102. In some embodiments, the communications engine 402 may tap into the digital service directly or may receive the context information from the user system 104 and/or user agent 108. Other options are also possible.

The offer rules database managing engine 404 includes hardware, software and/or firmware configured to retrieve the offer rules. The offer rules include the rules for determining whether to present an initial offer, whether to present each of one or more successive offers, and whether to invite a counteroffer from the user, and to generate the offer prices. In some embodiments, the offer rules also include the rules how economic data affects whether to present an offer and/or the offer prices. For example, the offer rules may define how current and past individual user behavior information, user group behavior information, economic factors, etc. affect a determination whether to present an initial offer, each successive offer and the prices.

It will be appreciated that the offer rules may differ depending on the amount of knowledge, namely, depending on whether the offer server system 110 is in a learning phase or a learned phase. During the learning phase, the offer rules may be configured to follow a default process, e.g., to send initial offers and perhaps one or more successive offers, every time that the offer server system 110 receives context information indicating a known or suspected interest of the individual user in a digital asset. That way, the offer server system 110 gathers intelligence on the negotiation/conversion behavior of the individual users. For example, the offer rules during the learning phase may indicate to instruct the sending of an initial offer for a discounted price off of the suggested price of the digital asset and/or for a different payment type or payment type combination. That way, the offer server system 110 can determine the general preferences of an individual user and possibly the general behaviors of user groups by demographics. During the learning phase, the offer rules may be configured to send no more than a predetermined number of offers, e.g., an initial offer and no more than two successive offers. That way, the offer server system 110 does not pester the disinterested user. During the learning phase, the initial offer may be for certain percentage below the suggested price. The first successive offer might be for a larger discount off the suggested price. The second successive offer might be for a different payment type or combination of payment types. After the offer server system 110 obtains intelligence on the individual user and/or the user's demographic, it might be apt to change its default process.

When the offer server system 110 is operating in the learned phase, the offer rules may be configured to conduct a process different than the default process, e.g., to send a custom initial offer and/or a custom successive offer. For example, as the offer server system 110 learns that a particular user does not like to spend more than a certain amount, the offer rules may indicate that no offer should be presented if the digital service provider's minimum price is above the maximum price this individual is ever willing to spend. Similarly, the offer server system 110 may have learned that an individual user is willing to watch advertisements, but is not willing to spend more than a certain amount. Accordingly, the offer rules may indicate that the initial offer might be for real currency just slightly above the user's comfort zone, plus a certain number of advertisements to make up the difference between the comfort amount and the minimum price demanded by the digital service provider. Sometimes, if rejected, the offer rules may dictate the sending of a first successive offer within the user's comfort zone. Other times, if rejected, the offer rules may dictate not sending a second successive offer within the user's comfort zone so that the individual user is aware that a “comfortable” offer is not always forthcoming. Further, the offer server system 110 may have learned that a user is willing to spend close to the suggested price whenever a cohort first purchases an item. In that case, the initial offer may be near the suggested price, and no successive offer may be forthcoming.

In some video game processing embodiments, during the learning phase, the offer rules may specify that an initial offer should go out whenever a trigger has identified a known or suggested interest in a digital asset. The offer rules may indicate that the initial offer should be sent offering the digital asset at some percentage, e.g., 10%, below the suggested price set by the digital service provider. The offer rules may indicate that, if the initial offer is rejected, a first successive offer should be sent offering the digital asset at some greater percentage, e.g., 25%, below the suggested price. The offer rules may indicate that, if the first successive offer is rejected, a second successive offer should be presented at 50% below the asking price plus 50% value in other payment types, e.g., watching of advertisements. The system can store the results relative to the context. Other offer rules are possible.

It will be appreciated that offers may be for a bundle of digital assets. In other words, the offer rules may indicate to present an initial or successive offer for a bundle of digital assets, possibly including a digital asset of known or suspected interest to the user, for a discounted price. Similarly, an initial offer may be for the digital asset of known or suspected interest, and the successive offer may be for a bundle that includes the digital asset of known or suspected interest. Other offer rules are possible.

In some video game processing embodiments, during the learned phase, the offer rules may specify that an initial offer should go out whenever a trigger has identified a known or suggested interest in a digital asset and the context indicates a need for a digital asset over a particular need threshold. The past individual user behavior may dictate the payment type and the level of discount. For example, if the user prefers to purchase digital assets if they are at a 25% discount, the offer rules may indicate the sending of an initial offer at 20% below the suggested price (which is slightly above the user's comfort zone). Similarly, if an individual user prefers not to spend more than $5 and is willing to watch advertisements, then the initial offer may be at $6 (slightly above the user's comfort zone) plus several advertisements to make up the difference between the increased comfort zone and the minimum price the digital service provider is willing to accept. If the individual user rejects the initial offer, then the offer rules may indicate that a successive offer designed to be more attractive to the user may be presented. Other offer rules are possible.

Similar offer rules may be applied in digital content delivery and application management embodiments.

The individual user behavior database managing engine 406 includes hardware, software and/or firmware configured to obtain the individual user context information from the communications engine 402 and to store the individual user behavior information into the data store 112. The individual user behavior database managing engine 406 is also configured to obtain the individual user behavior information from the data store 112 corresponding to the offer rules for the offer engine 412 as requested.

The user group behavior database managing engine 408 includes hardware, software and/or firmware configured to obtain the individual user context information from the communications engine 402, to process the individual user behavior information with other individual user behavior information or with user group behavior information to generate new user group behavior information, and to store the new user group behavior information into the data store 112. The user group behavior database managing engine 408 is also configured to obtain the user group behavior information from the data store 112 corresponding to the offer rules for the offer engine 412 as requested. The user group behavior database managing engine 408 may also be configured to obtain user group behavior information from external sources, such as economists.

The economic factors database managing engine 410 includes hardware, software and/or firmware configured to obtain economic factors from the digital service provider and/or external sources and to store the economic factors into the data store 112. Example economic factors from the digital service provider include pricing information for digital assets (e.g., minimum prices, suggested prices, etc.), and economic metrics (e.g., desired balance of real currency to virtual currency, desired balance of grind currency, desired profit, etc.). Example economic factors from external sources include stock market prices, market indicators, weather conditions, global events, national events, local events, political events, etc. Although the embodiment herein shows the economic factors from external sources being stored in the data store 112, one skilled in the art will recognize that several or all of the economic factors from the external sources may be obtained from the external sources on the fly. The economic factors database managing engine 410 is also configured to obtain the economic factors corresponding to the offer rules from the data store 112 and/or possibly from the external sources for the offer engine 412 as requested.

The offer engine 412 includes hardware, software and/or firmware configured to apply the offer rules obtained by the offer rules database managing engine 414. Using the rules and the individual user behavior information obtained by the individual user behavior database managing engine 406, the user group behavior information obtained by the user group behavior database managing engine 406, the economic factors obtained by the economic factors database managing engine 410, and other data, the offer engine 412 determines whether to present an initial offer for the digital asset of interest, determines whether to present each of one or more successive offers for the digital asset of interest, determines whether to invite the user to present a counteroffer, and generates the offers. The offer engine 412 may also be configured to evaluate a counteroffer presented by the user.

In some embodiments, the offer engine 412 (possibly using the offer rules and economic factors) may be configured to translate various payment types to a single payment type (e.g., real currency) for comparison. For example, the offer engine 412 may wish value a digital asset at $10. The offer engine 412 may be aware that the user always rejects initial offers over $5. Accordingly, the offer engine 412 may opt for an initial offer of $5 plus $5 worth of advertisements. In some embodiments, the offer engine 412 may need to translate the value of watching advertisements to generate the successive offer and/or may need to translate the value of a counteroffer to determine if it is within acceptable parameters.

The offer exchange server 414 includes hardware, software and/or firmware configured to send offers to the user and in some embodiments to the user agent 108. The offer exchange server 414 may be configured by the user to send mirror requests to the user agent 108, so that the user agent 108 can act as a proxy for the user, should the user not be available to respond to an offer, e.g., if the offer is only available during certain time windows when the user is unavailable.

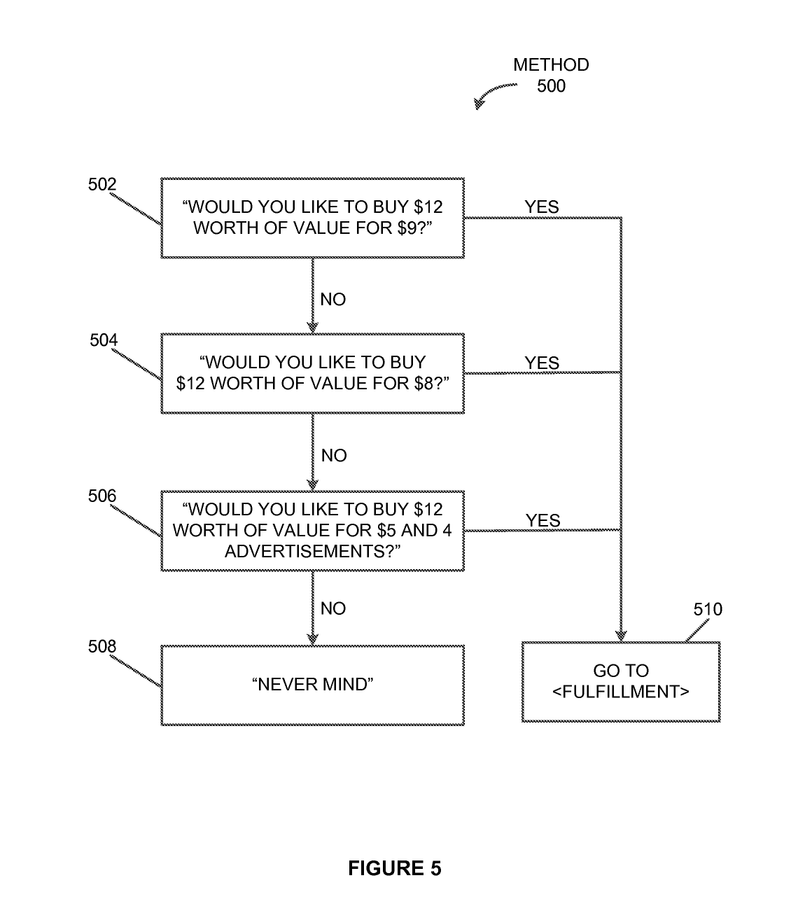

FIG. 5 is a flow diagram of an example method 500 of presenting offers from the offer server system 110 to the user, in accordance with some embodiments of the invention. The example method 500 of communications begins in step 502 with the offer server system 110 presenting an initial offer “Would you like to buy $12 worth of digital assets for $9?” If the user accepts the initial offer, the method 500 jumps to step 510 for fulfillment of the initial offer. If the user rejects the initial offer, the method 500 jumps to step 504 with the offer server system 110 deciding to present a first successive offer and presenting “Would you like to buy $12 worth of digital assets for $8?” If the user accepts the first successive offer, the method 500 jumps to step 510 for fulfillment of the first successive offer. If the user rejects the first successive offer, then the method 500 jumps to step 506 with the offer server system 110 deciding to present a second successive offer and presenting “Would you like to buy $12 worth of digital assets for $5 and 4 advertisements?” If the user accepts the second successive offer, then the method 500 jumps to step 510 for fulfillment of the second successive offer. If the user rejects the second successive offer, then method 500 jumps to step 508 with the offer server system 110 deciding not to present another successive offer and presenting “Never mind.”

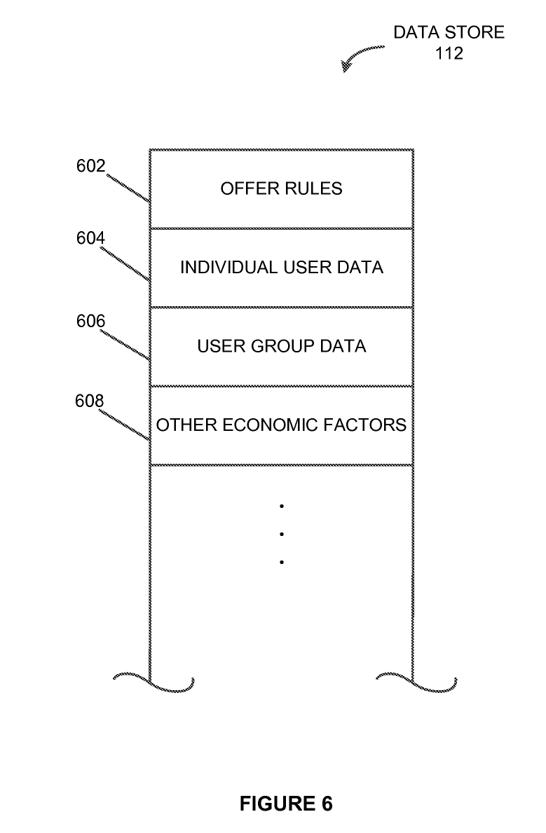

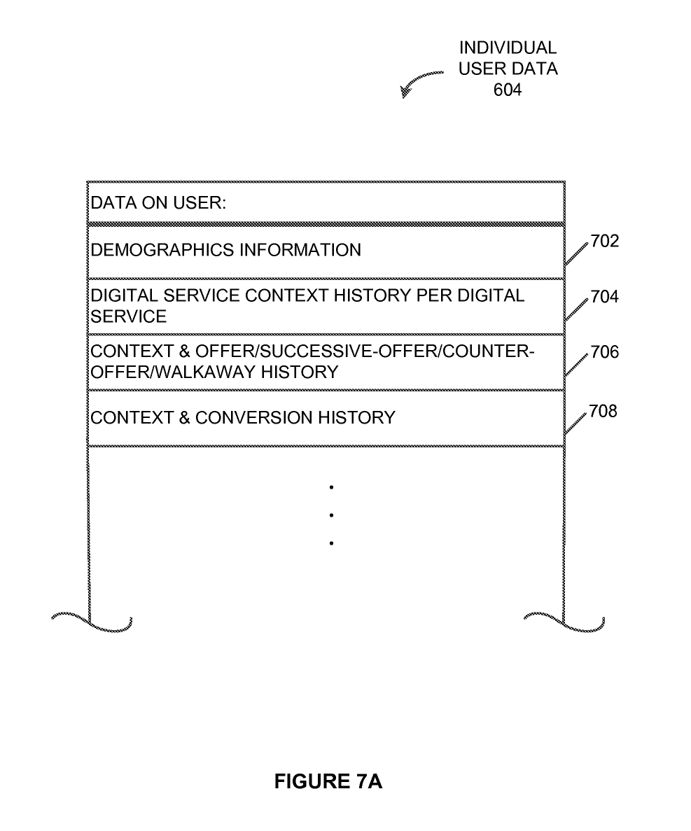

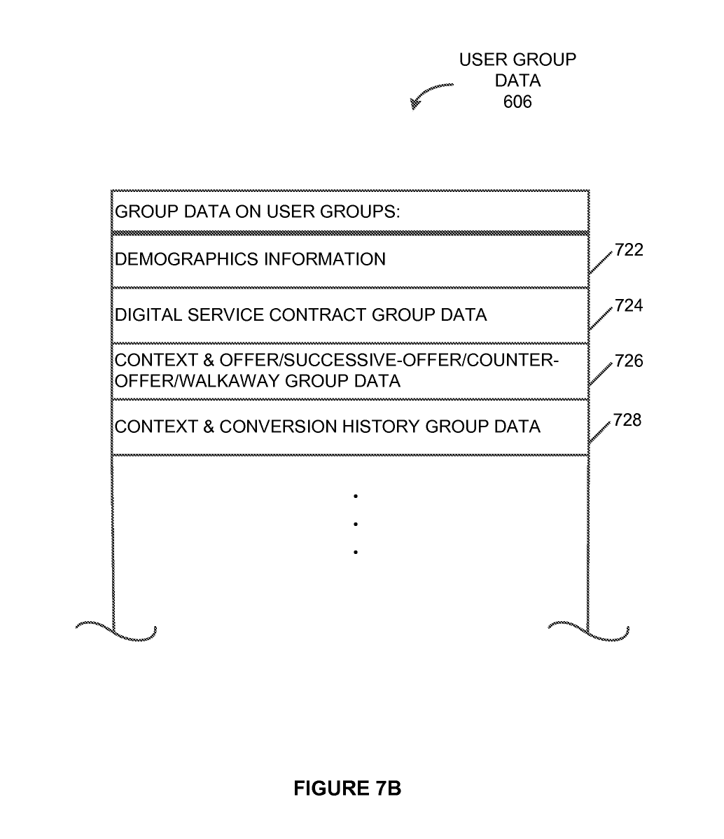

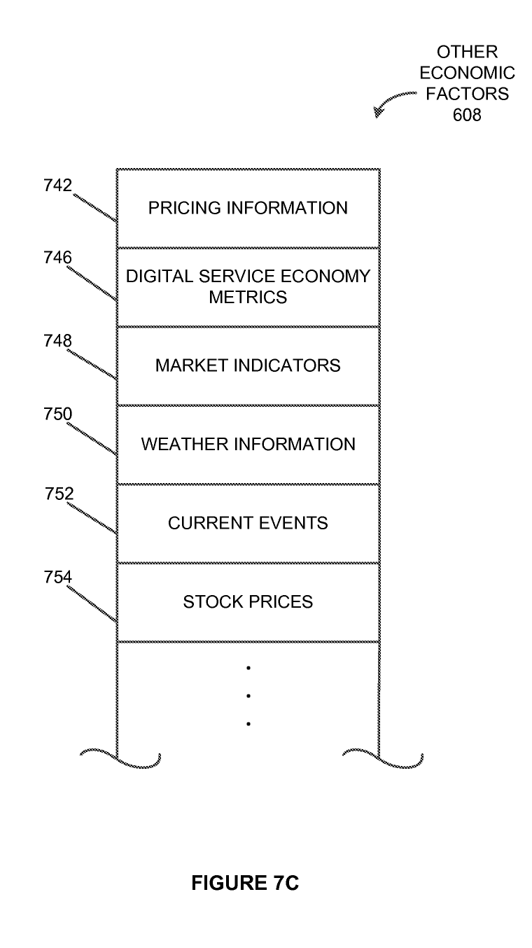

FIG. 6 is a block diagram of a data store 112, in accordance with some embodiments of the invention. The data store 112 includes offer rules 602, individual user data 604, user group data 606 and other economic data 608. An example of individual user data 604 is shown in FIG. 7A. An example of user group data 606 is shown in FIG. 7B. An example of economic factors 608 is shown in FIG. 7C.

FIG. 7A is a block diagram of individual user data 604, in accordance with some embodiments of the invention. The individual user data 604 includes, per user, demographic information 702, digital service context history 704 per digital service, context to offer/successive-offer/counteroffer/walkaway history 706, context to conversion history 708, and other individual user data. The demographic information 702 includes age, gender, race, religion, etc. The digital service context history 704 includes a history of digital context information presented to the offer server system 110. The context to offer/successive-offer/counteroffer/walkaway history 706 includes a history of initial and successive offers presented to the user, counter offers presented to the offer server system 110 and/or walkaway information corresponding to context. The context to conversion history 708 includes a history of the sales of digital assets corresponding to context.

FIG. 7B is a block diagram of user group data 606, in accordance with some embodiments of the invention. The user group data 606 includes, per user group, demographic information 722, digital service context group data 724, context to offer/successive-offer/counteroffer/walkaway group data 726, context to conversion history group data 728, and other user group data. The demographic information 722 includes user groups associated based on age, gender, race, religion, cohorts of an individual user, etc. The digital service context group data 724 includes information that may be relevant in determining what digital assets may be of interest to a user who belongs to or is associated with a group. The context to offer/successive-offer/counteroffer/walkaway group data 726 includes general and/or statistical information about initial and successive offers presented to the user, counter offers presented to the offer server system 110 and/or walkaway information corresponding to context. The general and statistical information may identify the context and offer patterns that lead to rejections. The context to conversion history group data 728 may include general and/or statistical information about the contexts and offer patterns that lead to acceptances.

FIG. 7C is a block diagram of other economic factors 608, in accordance with some embodiments of the present invention. The other economic factors 608 include pricing information 742, digital service economy metrics 746, market indicators 748, weather information 750, current events 752, stock prices 754 and other group data. As mentioned above, pricing information 742 and digital service economy metrics 746 are examples of economic data provided by the digital service provider. The pricing information 742 may include minimum or suggested pricing for a digital asset based on context. The digital service economy metrics 746 may include parameter to assist with tuning the virtual economy of the digital service. Market indicators 748, weather information 750, current events 752 and stock prices 754 are examples of economic data obtained from external sources. The market indicators 748 may include NASDAQ and NYSE information, particular stock prices, etc. It will be appreciated that, although the data store 112 is being shown to store various economic factors from external sources, one skilled in the art will recognize that the offer server system 110 may reach out to external sources on the fly to obtain the economic data, e.g., time of day, weather information 750, current events 752, stock prices 754, etc.

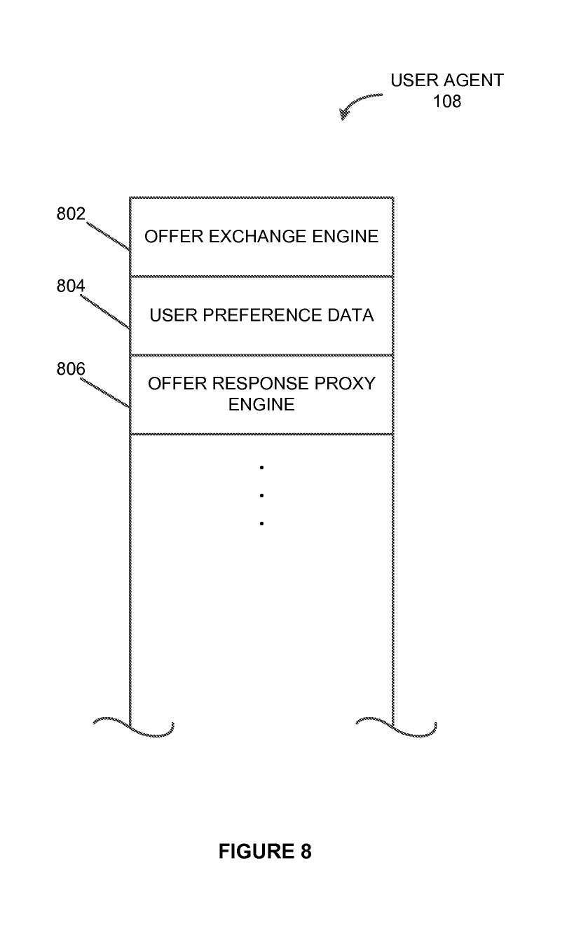

FIG. 8 is a block diagram of a user agent 108, in accordance with some embodiments of the invention. The user agent 108 includes an offer exchange engine 802, user preference data 804 and an offer response proxy engine 806. The offer exchange engine 802 includes hardware, software and/or firmware configured to receive offers from the offer server system 110, to present responses, and/or to present counteroffers if so invited. The user preference data 804 includes user configuration information that specifies the parameters that a user would be willing to accept an offer for a digital asset, the parameters that a user would be willing to reject an offer for a digital asset, the parameters to present a counteroffer, etc. For example, the user may specify the price that the user is willing to pay, the discount that the user must receive, whether to accept an initial offer ever, etc. The offer response proxy engine 806 will use the user preference data 804 to determine whether to accept or reject an initial offer, whether to accept or reject each of one or more successive offers, whether to present a counteroffer, and how much to counteroffer.

In some embodiments, the user preference data may also specify contexts associated with the acceptance/rejection/counteroffer parameters. In those embodiments, the user agent 108 needs to also receive the context information after a trigger is identified. In some embodiments, the offer exchange server 414 of the offer server system 110 may present the context information to the user agent 108. In other embodiments, the digital service system 102 may present the context information to the user agent 108.

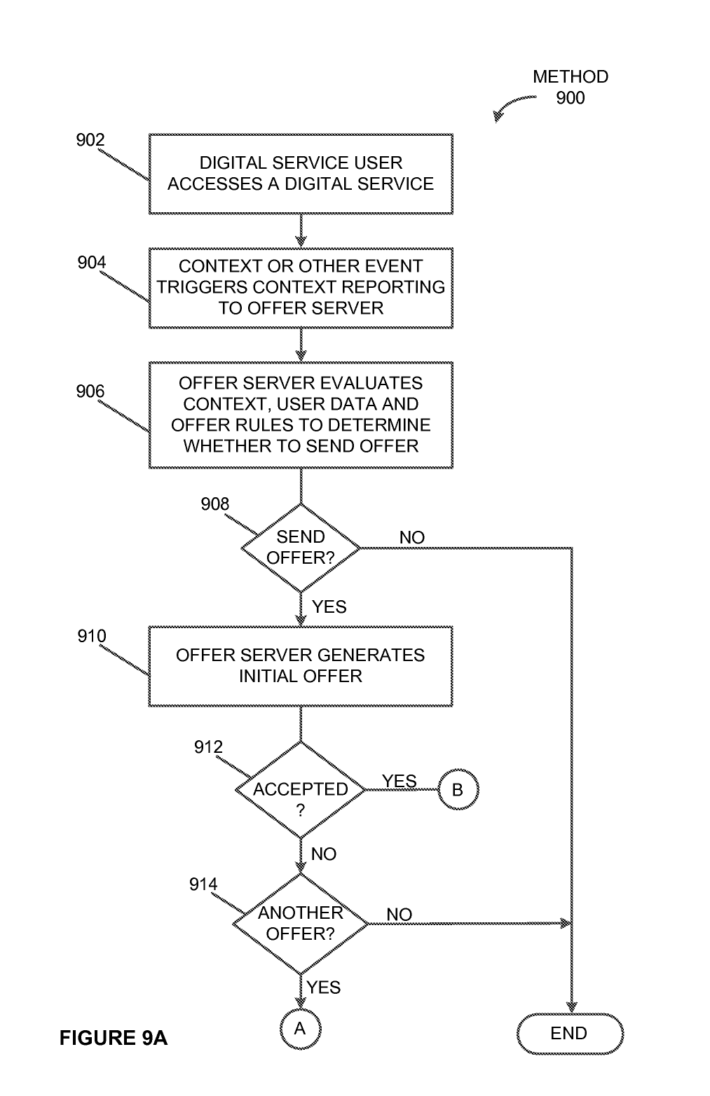

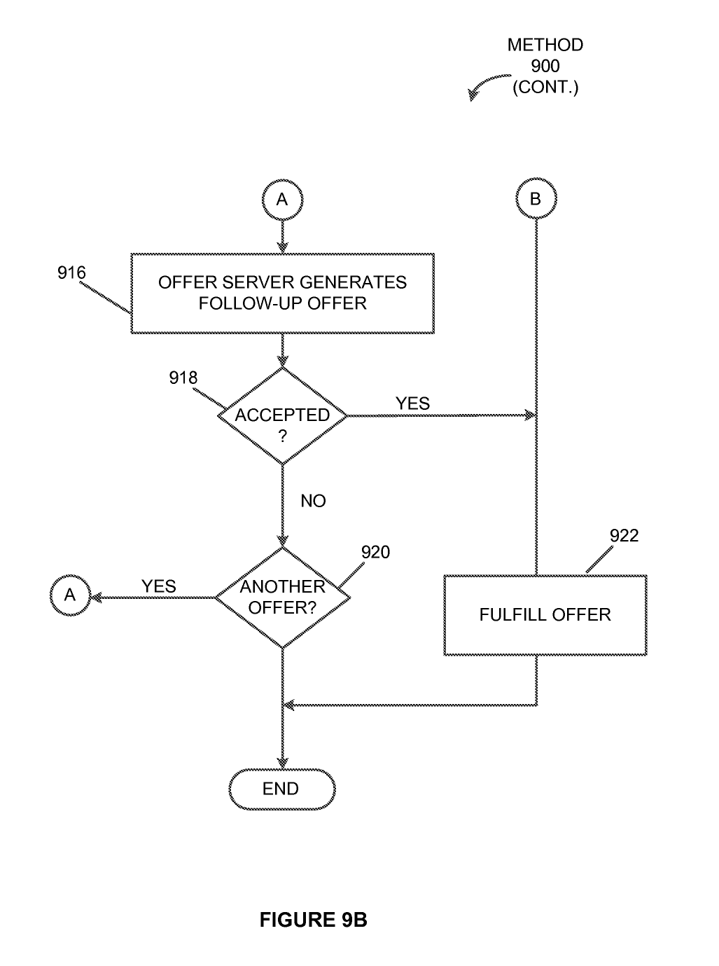

FIGS. 9A and 9B are a flowchart of a method 900 of enabling successive offers for the sale of a digital asset of a digital service, in accordance with some embodiments of the invention. Method 900 begins in step 902 with the user of a user system 104 accessing a digital service provided by the digital service system 102. The user behavior of the user in step 904 is monitored, e.g., by the digital service system 102, and a determination, e.g., by the digital service system 102, is made whether the user behavior or any other event satisfies a trigger to report context information to the offer server system 110. In step 906, offer rules are applied to the context information, individual user behavior information, user group behavior information and other economic factors to decide whether to present an initial offer for a digital asset known or suspected to be of interest to the user, e.g., by the offer server system 110. In step 908, a determination is made, e.g., by the offer server system 110, whether to send the initial offer. If not, method 900 ends. If so, then in step 910, an initial offer is generated, e.g., by the offer server system 110, based on the offer rules, the context information, individual user behavior information, user group behavior information and other economic factors, and the initial offer is sent to the user (and/or possibly to the user agent 108), e.g., by the offer server system 110. In step 912, a response is awaited from the user (and/or possibly from the user agent 108), e.g., by the offer server system 110. If a response to the initial offer is an acceptance, then the method 900 jumps to step 922 so that the offer can be fulfilled, e.g., by the digital service system 102. If a received response to the initial offer is a rejection (e.g., a timeout), then in step 914 a determination is made, e.g., by the offer server system 110, whether to send a successive offer. If a decision is made not the send a successive offer, then method 900 ends. If a response to the initial offer is a rejection and a determination is made to present a successive offer, then in step 916 a successive offer is generated, e.g., by the offer server system 110. In step 918, a response to the successive offer is awaited from the user (and/or possibly from the user agent 108), by the offer server system 110. If a received response to the successive offer is an acceptance, then the method 900 jumps to step 922 so that the successive offer can be fulfilled, e.g., by digital service system 102. If a received response to the successive offer is a rejection (including a timeout), then in step 920 a determination is made, e.g., by the offer server system 110, whether to send another successive offer. If so, then method 9000 returns to step 916. If not, then method 900 ends.

FIG. 10 is a block diagram of an computer system 1000. The computer system 1000 comprises a processor 1002, a memory system 1004, a storage system 1006, a communication network interface 1008, an I/O interface 1010, and a display interface 1012 communicatively coupled to a communication channel 1014. The processor 1002 is configured to execute executable instructions (e.g., code). In some embodiments, the processor 1002 comprises circuitry and/or any processor capable of processing the executable instructions.

The memory system 1004 is any memory configured to store data. Some examples of the memory system 1004 include storage devices, such as RAM, ROM, RAM cache, etc. In various embodiments, data is stored within the memory system 1004. The data within the memory system 1004 may be cleared or ultimately transferred to the storage system 1006.

The storage system 1006 is any storage configured to retrieve and store data. Some examples of the storage system 1006 are flash drives, hard drives, optical drives, and/or magnetic tape. In some embodiments, the computer system 1000 includes a memory system 1004 in the form of RAM and a storage system 1006 in the form of flash. Both the memory system 1004 and the storage system 1006 comprise computer readable media which may store instructions that are executable by the processor 1002.

The communication network interface (com. network interface) 1008 can be coupled to a network (e.g., computer network 116) via the communication channel 1016. The communication network interface 1008 may support communication over an Ethernet connection, a serial connection, a parallel connection, or an ATA connection, for example. The communication network interface 1008 may also support wireless communication (e.g., 802.11 a/b/g/n, WiMax). It will be apparent to those skilled in the art that the communication network interface 1008 can support many wired and wireless standards.

The input/output (I/O) interface 1010 is any device that receives input from the user and outputs data to the user. The display interface 1012 is any device that is configured to output graphics and data to a display. In one example, the display interface 1012 is a graphics adapter. It will be appreciated that not all computer systems 1000 comprise either the I/O interface 1010 or the display interface 1012.

It will be appreciated by those skilled in the art that the hardware elements of the computer system 1000 are not limited to those depicted. A computer system 1000 may comprise more or less hardware elements than depicted. Further, hardware elements may share functionality and still be within various embodiments described herein. In one example, encoding and/or decoding may be performed by the processor 1002 and/or a co-processor located on a GPU (e.g., Nvidia). The above-described functions and components may comprise instructions stored on a storage medium such as a computer readable medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

It will be appreciated that an “engine” as referred to herein may comprise software, hardware, firmware, and/or circuitry. In one example, one or more software programs comprising instructions capable of being executable by a processor may perform one or more of the functions of the engines described herein. In another example, circuitry may perform the same or similar functions. Alternative embodiments may comprise more, less, or functionally equivalent engines and still be within the scope of present embodiments.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

1. A system comprising:
a context monitoring engine configured to monitor context information of a user of a video game, the video game having an in-game economy controlled by the video game, the video game having digital assets with real-currency values based on the in-game economy, some of the digital assets possibly having virtual values to the user in the video game, the context information identifying a possible interest of the user in a particular digital asset;
a communications engine configured to receive the context information of the user;
a rules engine configured to obtain offer rules;
an economic data engine configured to obtain economic data associated with the offer rules, the economic data including a particular real-currency value based on the in-game economy for the particular digital asset, the economic data further including past user behavior information involving one or more past offers presented to the user; and
an offer engine configured to:
first determine based on the offer rules and on the economic data whether to present a first offer for the particular digital asset, the offer rules instructing the offer engine to evaluate the past user behavior information of the user to first determine whether to present the first offer to the user;
if the offer engine determines to present the first offer, generate the first offer for the digital asset based on the economic data and on the offer rules;
if the first offer is refused by the user, second determine based on the offer rules and on the economic data whether to present a successive offer for the digital asset, the offer rules instructing the offer engine to evaluate the past user behavior information to second determine whether to present the successive offer to the user; and
if the offer engine determines to present the successive offer, generate the successive offer based on the economic data including the past user behavior information and on the offer rules, the successive offer being designed to be more attractive to the user than the first offer.

2. (canceled)

3. The system of claim 1, wherein the digital service includes digital content delivery.

4. The system of claim 1, wherein the digital service includes application management.

5. The system of claim 1, wherein the economic data includes pricing information set by a digital service provider.

6. The system of claim 1, wherein the economic data includes individual user behavior information of the user.

7. The system of claim 1, wherein the economic data includes behavior information of a user group to which the user belongs or is associated.

8. The system of claim 1, further comprising an offer exchange server that sends the first offer to the user.

9. The system of claim 1, further comprising an offer exchange server that sends the first offer to a user agent.

10. The system of claim 1, wherein the first offer and the successive offer comprise different payment types or combinations of payment types.

11. A method comprising:
monitoring context information of a user of a video game, the video game having an in-game economy controlled by the video game, the video game having digital assets with real-currency values based on the in-game economy, some of the digital assets possibly having virtual values to the user in the video game, the context information identifying a possible interest of the user in a particular digital asset;
receiving the context information of the user;
obtaining offer rules;
obtaining economic data associated with the offer rules, the economic data including a particular real-currency value based on the in-game economy for the particular digital asset, the economic data further including past user behavior information involving one or more past offers presented to the user;
first determining, by one or more processors, based on the offer rules and on the economic data whether to present a first offer for the particular digital asset, the offer rules instructing the offer engine to evaluate the past user behavior information of the user to first determine whether to present the first offer to the user;
if a first determination is made to present the first offer, generating the first offer for the digital asset based on the economic data and on the offer rules;
if the first offer is refused by the user, second determining based on the offer rules and on the economic data whether to present a successive offer for the digital asset, the offer rules instructing the offer engine to evaluate the past user behavior information to second determine whether to present the successive offer to the user; and
if a second determination is made to present the successive offer, generating, by the one or more processors, the successive offer based on the economic data including the past user behavior information and on the offer rules, the successive offer being designed to be more attractive to the user than the first offer.

12. (canceled)

13. The method of claim 11, wherein the digital service includes digital content delivery.

14. The method of claim 11, wherein the digital service includes application management.

15. The method of claim 11, wherein the economic data includes pricing information set by a digital service provider.

16. The method of claim 11, wherein the economic data includes individual user behavior information of the user.

17. The method of claim 11, wherein the economic data includes behavior information of a user group to which the user belongs or is associated.

18. The method of claim 11, further comprising sending the first offer to the user.

19. The method of claim 11, further comprising sending the first offer to a user agent.

20. The method of claim 11, wherein the first offer and the successive offer comprise different payment types or combinations of payment types.

21. A non-transitory computer readable medium comprising instructions, the instructions being executable by a processor to perform a method, the method comprising:
monitoring context information of a user of a video game, the video game having an in-game economy controlled by the video game, the video game having digital assets with real-currency values based on the in-game economy, some of the digital assets possibly having virtual values to the user in the video game, the context information identifying a possible interest of the user in a particular digital asset;
receiving the context information of the user;
obtaining offer rules associated with the context information;
obtaining economic data associated with the offer rules, the economic data including a particular real-currency value based on the in-game economy for the particular digital asset, the economic data further including past user behavior information involving one or more past offers presented to the user;
first determining based on the offer rules and on the economic data whether to present a first offer for the particular digital asset, the offer rules instructing the offer engine to evaluate the past user behavior information of the user to first determine whether to present the first offer to the user;
if a first determination is made to present the first offer, generating the first offer for the digital asset based on the economic data and on the offer rules;
if the first offer is refused by the user, second determining based on the offer rules and on the economic data whether to present a successive offer for the digital asset, the offer rules instructing the offer engine to evaluate the past user behavior information to second determine whether to present the successive offer to the user; and
if a second determination is made to present the successive offer, generating the successive offer based on the economic data, the successive offer based on the economic data including the past user behavior information and on the offer rules, the successive offer being designed to be more attractive to the user than the first offer.

22. The system of claim 1, wherein the economic data is associated with an interest of the user in the digital asset.

23. The method of claim 11, wherein the economic data is associated with an interest of the user in the digital asset.
